(19) United States
(12) Patent Application Publication
(10) Pub. No.: US 2013/0207882 A1
(43) Pub. Date: Aug. 15, 2013

(54) METHODS AND APPARATUS TO OBTAIN AND PRESENT INFORMATION

(71) Applicants: James Allen Hymel, Kitchener (CA); Jean Philippe Bouchard, Waterloo (CA); Edvard Kikic, Kitchener (CA); Thomas Edward Byrd, Wokingham (GB); William Alexander Paton, Simcoe (CA)

(72) Inventors: James Allen Hymel, Kitchener (CA); Jean Philippe Bouchard, Waterloo (CA); Edvard Kikic, Kitchener (CA); Thomas Edward Byrd, Wokingham (GB); William Alexander Paton, Simcoe (CA)

(21) Appl. No.: 13/635,317

(22) PCT Filed: Aug. 8, 2011
(86) PCT No.: PCT/CN11/50479

§ 371 Date: Sep. 14, 2012

(51) Int. Cl. G09G 5/00

(52) U.S. Cl. CPC G09G 5/00
USPC 345/2.3

(57) ABSTRACT

Example methods and apparatus to display information are described. On example method includes a method including a mobile device exchanging information with at least one other mobile device; controlling transmission of media, to the mobile device and the at least one other mobile device, based on attributes of the mobile devices; and presenting the received media.

### FIELD OF THE DISCLOSURE

The present disclosure relates generally to mobile devices and, more particularly, to methods and apparatus to obtain and present information.

### BACKGROUND

Presenting information in the form of graphical images to a number of users typically includes the use of a projector. Information to be presented is provided to the projector, which converts such information into graphical images and presents the graphical images on, for example, a screen or a wall.

In some examples, multiple projectors may be used to present portions of graphical images associated with the information. As projector technology has progressed, projectors have become smaller and could be integrated into mobile devices, such as mobile telephones.

### BRIEF DESCRIPTION OF THE DRAWINGS

FIG. 1 illustrates an example system for obtaining media and/or controlling the presentation of the media information in manners that are dependent upon attributes of one or more mobile devices.

FIG. 2 illustrates example functionality of the controller of FIG. 1.

FIG. 3 illustrates an example flow diagram representative of a method, which may be implemented using computer readable instructions, that may be used to gather information, such as media, in accordance with the system of FIG. 1.

FIG. 4 illustrates an example flow diagram representative of a method, which may be implemented using computer readable instructions, that may be used to present information, such as media, in accordance with the system of FIG. 1.

FIG. 5 is a block diagram of a mobile device in accordance with an example embodiment.

### DETAILED DESCRIPTION

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

For simplicity and clarity of illustration, where considered appropriate, reference numerals may be repeated among the figures to indicate corresponding or analogous elements. In addition, numerous specific details are set forth in order to provide a thorough understanding of examples disclosed herein. However, it will be understood by those of ordinary skill in the art that examples disclosed herein may be practiced without these specific details. In other instances, well-known methods, procedures and components have not been described in detail so as not to obscure examples disclosed herein. Also, the description is not to be considered as limiting the scope of examples disclosed herein.

Example methods, apparatus, and articles of manufacture disclosed herein may be used in connection with telephony-capable mobile devices, which may be any mobile communication device, mobile computing device, or any other element, entity, device, or service capable of communicating wirelessly. Mobile devices, also referred to as terminals, wireless terminals, mobile stations, communication stations, user equipment (UE), or user devices, may include mobile smartphones (e.g., BlackBerry® smartphones), cellular telephones, wireless personal digital assistants (PDA), tablet/laptop/notebook/netbook computers with wireless adapters, etc.

Example methods, apparatus, and articles of manufacture disclosed herein facilitate operations in a mobile device. In one example, such methods may include exchanging information with one or more other mobile devices, controlling transmission of media to the one or more mobile devices, based on attributes of the mobile device and attributes of the one or more other mobile devices, and presenting the received media. An example apparatus may include a mobile device comprising a projector to present images, a communication subsystem to exchange information with one or more other mobile devices, and a controller to control transmission of media to the one or more mobile devices, based on attributes of the mobile device and attributes of the one or more other mobile devices.

Additionally, such methods may include exchanging information with one or more other mobile devices and controlling presentation of media based on attributes of the mobile device and attributes of the one or more other mobile devices. An example apparatus may include a mobile device comprising a projector to present images, a communication subsystem to exchange information with one or more other mobile devices, and a controller to control presentation of media based on attributes of the mobile device and attributes of the one or more other mobile devices.

As described herein, the methods, apparatus, and articles of manufacture include obtaining and/or presenting information, such as media, based on attributes of one or more mobile devices. By using the attributes of the mobile devices as criteria for obtaining and presenting information, the strengths and weaknesses of the mobile devices may be considered and the obtaining or gathering of the information to be presented can be allocated to provide an enhanced user experience. For example, one mobile device may be a master mobile device that obtains attributes from other mobile devices and considers those attributes, such as data connectivity information (e.g., communication signal quality, data communication speed, data network connectivity, etc.) and/or device attributes (e.g., battery life, processing speed, projector capabilities, etc.), to determine which device(s) should obtain, or receive, and/or present media. For example, the master mobile device may direct another mobile device with a Wireless Fidelity (Wi-Fi) connection and a long remaining battery life to receive media that may be presented by another device or devices having superior projector attributes or processing power.

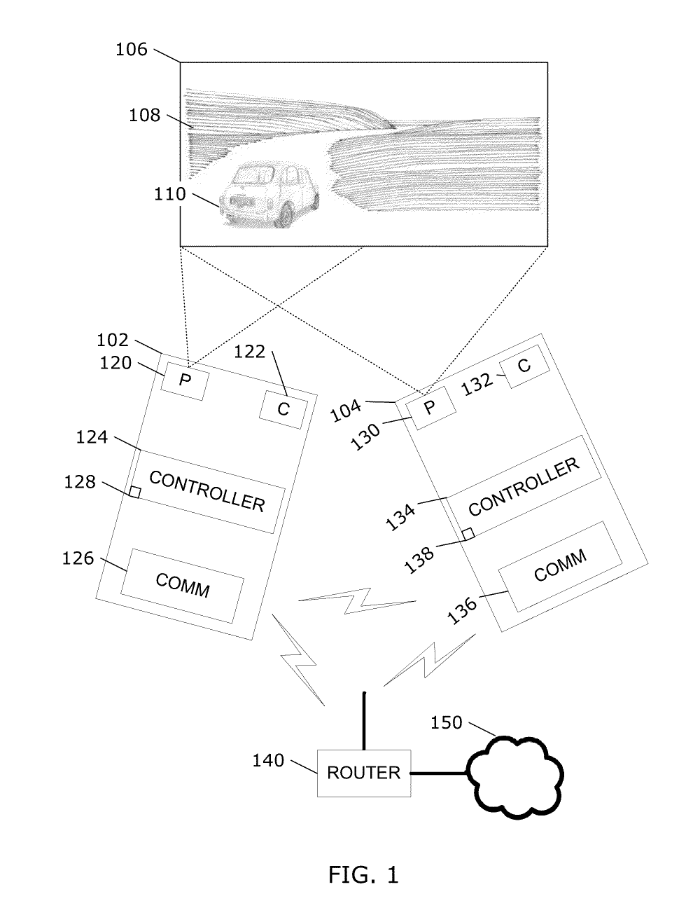

As shown in FIG. 1, a first mobile device 102 and a second mobile device 104 cooperate to display a presentation 106, which is a collection of media (e.g., graphics and/or sound). In the example of FIG. 1, the presentation 106 includes a background 108 which substantially spans the width of the presentation 106 and also includes an image of a car 110, which is located on the left side of the presentation 106. In one example, the background 108 may be a substantially static image and the car 110 may be a dynamic image (e.g., a motion picture or video). Media may also include audio that may also be gathered and presented. In the example of FIG. 1, the first mobile device 102 may present the car 110, while the second mobile device 104 may present the background. In other examples, the presentation 106 may be divided in any suitable manner. For example, the first mobile device 102 could present the car 110 and some of the background 108 on the left side of the presentation 106, while the second mobile device 104 may present other aspects of the background 108 on both the left and right sides of the presentation 106. As described below, the first and second mobile devices 102, 104 may coordinate their operation such that the best mobile device for a particular task is used for that task.

In the example of FIG. 1, the first mobile device 102 includes a projector 120, a camera 122, a controller 124, and a communication subsystem 126. The controller 124 may include hardware or may be programmed with software, firmware, coding, or any other suitable logic 128 to facilitate the functionality described herein.

The projector 120 may be a laser projector or any other suitable presentation device that is suitable to be implemented within the first mobile device 102. In one example, the projector 120 may be a pico-projector, which may be embedded in the first mobile device 102. In one alternative, the projector 102 may be connected to the first mobile device 102 as an accessory.

The camera 122 may be a still camera or a moving picture camera or any suitable camera that may be implemented within the first mobile device 102. The camera 122 could be implemented using a CMOS-based image sensor of any credible pixel rating. The camera 122 may be embedded in the first mobile device 102 and can be monoscopic (e.g., may include a single lens) or stereoscopic (e.g., may include dual or multiple lenses).

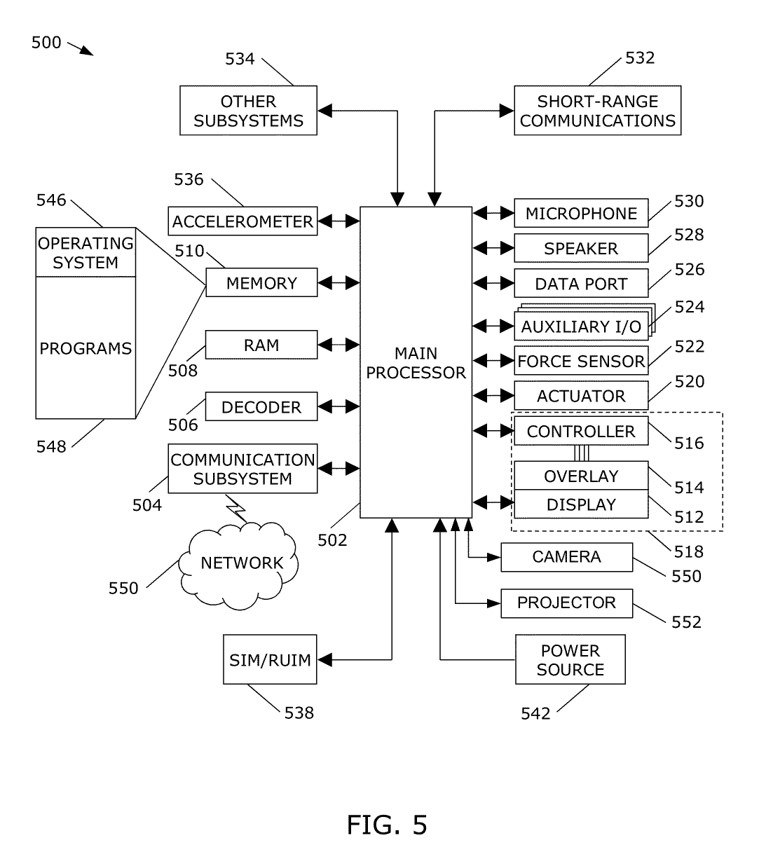

The controller 124 may be a processor and memory, a microcontroller, or any suitable logic device that may be used to carry out the functionality described herein. In one example, the controller may be programmed with logic 128, such as software, firmware, hard-coded instructions, etc. The controller 124 may also be implemented using the processor 502 and/or associated memories (e.g., the RAM 508 or the memory 510) of FIG. 5.

The communication subsystem 126 may be implemented using any suitable communication technology to provide the first mobile device 102 with a communication link. For example, the communication subsystem 126 may facilitate communication links with cellular networks, Wi-Fi networks, Bluetooth components, or any other suitable communication technology.

In the example of FIG. 1, the second mobile device 104 includes a projector 130, a camera 132, a controller 134, and a communication subsystem 136. The controller may include hardware, software, firmware, coding or any other suitable logic 138 to facilitate the functionality described herein. The implementation of these components may be similar or identical to those described above in conjunction with the first mobile device 102.

The communication subsystem 126 may be implemented using one or both of the short-range communication subsystem 532 or the communication subsystem 504 of FIG. 5. The communication subsystems 126, 136 of the first and second mobile devices 126, 136 may be configured to facilitate direct communications between the first and second mobile devices 126, 136. Alternatively, or additionally, the communication subsystems 126, 136 may be used to facilitate communications with, for example, a router 140 coupled to a network 150, such as the internet. As explained herein, the first and second mobile devices 102, 104 may determine their attributes (e.g., network connection, battery life remaining, etc.) and may exchange their attributes. The attributes can then be used to determine how media should be obtained or gathered and how the media should be presented. While the first mobile device 102 is described herein as the master device that receives the attributes and determines how media should be gathered and presented, this need not be the case. In fact, these determinations may be made by the second mobile device 104 or may be distributed between the first and second mobile devices 102, 104 in any suitable manner.

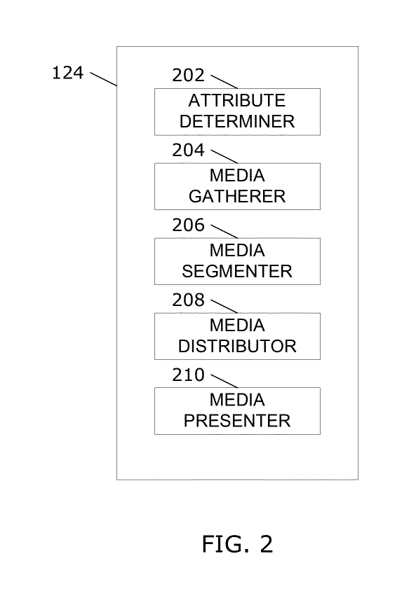

FIG. 2 shows further detail regarding the relevant functionality performed by the controller 124. As shown in the example of FIG. 2, the controller 124 includes an attribute determiner 202, a media gatherer 204, a media segmenter 206, a media distributor 208, and a media presenter 210. The functionality shown in FIG. 2 may be implemented using hard-coded instructions, hardware, software, firmware, or any other suitable combination thereof or any other form of logic.

The attribute determiner 202 obtains the attributes that are relevant for gathering and presentation of media. For example, the attribute determiner 202 may obtain data connectivity information, such as communication signal quality, data communication speed, data network connectivity, etc. Additionally, the attribute determiner 202 may obtain data regarding processing speed of the first mobile device 102, graphics processing power of the mobile device 102, projector capabilities, remaining battery life, whether the first mobile device 102 is connected to a permanent power source (e.g., a wall power outlet), etc. While the foregoing information is illustrative of the nature of the information or attributes that may be obtained or determined, such examples are not limiting. That is, any suitable information may be gathered by the attribute determiner 202 to determine how media should be gathered and presented.

The media gatherer 204 uses information from the attribute determiner 202 to determine which of the mobile devices 102, 104 should gather or receive certain portions of the media. For example, if the second mobile device 104 has more battery life left or a better wireless connection, and the media is to be obtained from a remote location such as a server, the media gatherer 204 will instruct the second mobile device 104 to handle receipt of the media from the remote location, and to transfer a portion of the media to first mobile device 102. Thus, the media gatherer 204 distributes media gathering responsibilities based on attributes of the mobile devices 102, 104.

The media segmenter 206 controls the distribution of the presentation of media, or media, based on the attributes of the mobile devices 102, 104. For example, attributes related to presentation capabilities, processing speed, battery life, audio capability, etc. may be used to determine how the media segmenter 206 should divide the media being presented. For example, if one of the devices is capable of displaying a larger image at the same distance from the screen than the other mobile device, that image would be automatically scaled down to match the size presented by the less capable device. Additionally, if one of the devices is capable of displaying a larger image, that device can be instructed to not render a portion of the screen, and let that portion be rendered and presented by the less capable device. In another distribution made by the media segmenter 206, one of the devices can render and present the static part of the image, with the moving part not rendered, while the other could render and present the moving part of the image. As a further example, if the devices are not fast enough to render and present a fluid motion video (e.g., at least 24 frames per second) then the devices can share the load by presenting only even and odd frames, each presentation on the same location, thereby sharing the load. Audio may be segmented for presentation on multiple devices, or may be presented on a single mobile device.

The media distributor 208 distributes the media as per the segmentation determined by the media segmenter 206. For example, if the second mobile device 104 is instructed to render a static image and that static image is not stored on the second mobile device 104, the first mobile device 102 can transfer the static image to the second mobile device 106. In one example, media may be only be stored on one of the devices, and may be transferred to the second device on an as-needed basis so that basically the second device only works as a projector and has minimal media stored thereon. The devices have a wired or wireless synchronization method (Wi-Fi, wireless Universal Serial Bus (USB), Near Field Communication (NFC)) and the media may be transferred during presentation of the media. In another example, media may be transferred from first mobile device 102 to second device 106 before presentation starts. Again, a wired or wireless transfer mechanism is used for syncing the media files. In another example, before presentation starts, the devices obtain access to a remote location (such as a server) at which the media is stored. Before presentation starts, both devices start to receive the media from the remote location, and store it in buffer memory to make sure there is continuous presentation, even if receipt of the media is slow for one of the devices.

The media presenter 210 renders and presents the media that is to be presented by the first mobile device 102. In some examples, the media presenter 210 may be responsible for coordinating the media presentation across multiple mobile devices. This synchronization may be carried out using codes (e.g. bar codes or other synchronization markers or tools) embedded in the media that may be recognized by the cameras 122, 132, or may be carried out by communication between the mobile devices 102, 104 via the communication subsystems 126, 136.

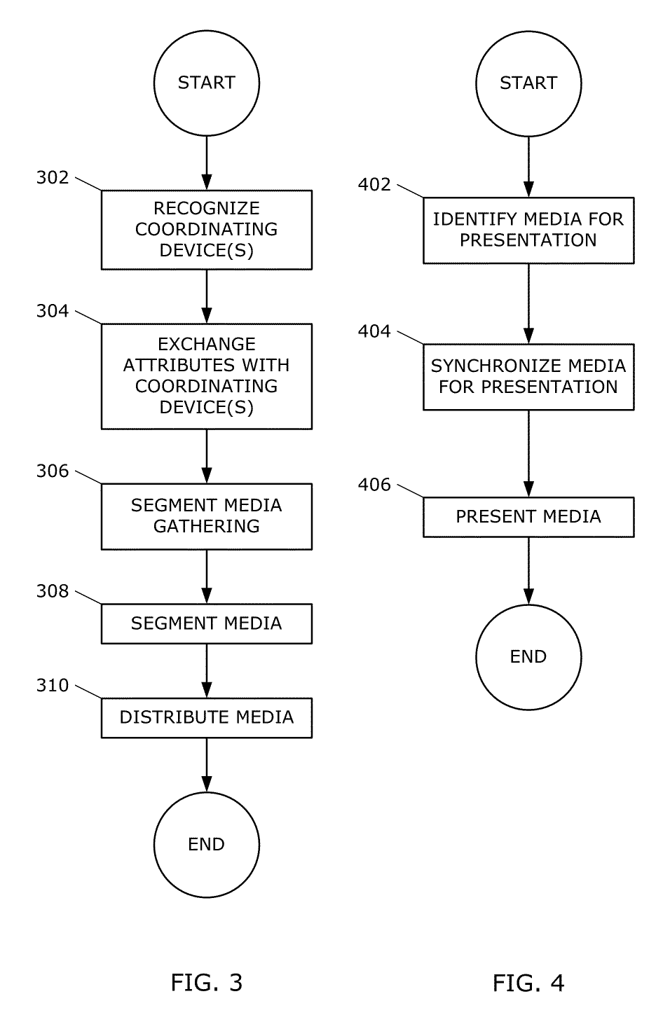

FIGS. 3 and 4 illustrate example flow diagrams representative of methods that may be implemented using, for example, computer-readable instructions stored on a computer-readable medium to media gathering and presentation control based on mobile device attributes. The example methods of FIGS. 3 and 4 may be performed using one or more processors, controllers, and/or any other suitable processing devices. For example, the example methods of FIGS. 3 and 4 may be implemented using coded instructions (e.g., computer readable instructions) stored on one or more tangible computer readable media such as flash memory, read-only memory (ROM), and/or random-access memory (RAM). For example, the controllers 124, 134, or the processor 502 may implement the methods of FIGS. 3 and 4.

As used herein, the term tangible computer readable medium is expressly defined to include any type of computer readable storage and to exclude propagating signals. Additionally or alternatively, the example methods of FIGS. and 4 may be implemented using coded instructions (e.g., computer-readable instructions or machine-accessible instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information).

As used herein, the term non-transitory computer-readable medium and non-transitory machine-accessible medium are expressly defined to include any type of computer-readable medium or machine-accessible medium and to exclude propagating signals.

Alternatively, some or all operations of the example methods of FIGS. 3 and 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all operations of the example methods of FIGS. 3 and 4 may be implemented manually or as any combination(s) of any of the foregoing techniques, for example, any combination of firmware, software, discrete logic and/or hardware. Further, although the example methods of FIGS. 3 and 4 are described with reference to the flow diagrams of FIGS. 3 and 4, other methods of implementing the methods of FIGS. 3 and 4 may be employed. For example, the order of execution of the blocks may be changed, and/or some of the blocks described may be changed, eliminated, sub-divided, or combined. Additionally, any or all operations of the example methods of FIGS. 3 and 4 may be performed sequentially and/or in parallel by, for example, separate processing threads, processors, devices, discrete logic, circuits, etc.

In the illustrated example, the methods of FIGS. 3 and 4 are described below as performed by the mobile device 102 of FIG. 1. However, the example methods of FIGS. 3 and 4 may additionally or alternatively be implemented using mobile device 104 of FIG. 1 or any other suitable device or apparatus.

Now turning to FIG. 3, an example method including media gathering and distribution is shown. The method of FIG. 3 may be implemented using, for example, computer-readable instructions or any suitable combination of hardware and/or software. The first mobile device 102 recognizes coordinating devices (block 302). Coordinating devices may be any devices with which the first mobile device 102 will share media gathering and/or media presentation operations. For example, with reference to the system of FIG. 1, the first mobile device 102 may recognize the second mobile device 104 as a coordinating device. The recognition of coordinating devices may be an automatic activity or a manual activity. For example, the first and second mobile devices 102, 104 may be directly paired together using Bluetooth, NFC, or any other technology. Alternatively, the first and second mobile devices 102, 104 may be paired through another device, such as the router 140.

The first mobile device 102 exchanges attributes with coordinating devices (block 304). In one example, the exchange may be a two-way exchange of attributes or may be a one way exchange of attributes, wherein the first mobile device 102 receives the attributes from all coordinating devices (e.g., the second mobile device 104). As noted above, the attributes may be data connectivity information (e.g., communication signal quality, data communication speed, data network connectivity, etc.) or may be any other device attributes (e.g., battery life, projector capabilities, processing speed, etc.).

Based on the attributes, the first mobile device 102 segments gathering or receipt of the media amongst coordinating devices (block 306). As noted above, the segmentation may be based on battery life, download speed, or any other suitable information or attributes of coordinating devices. The first mobile device 102 also gathers the media for which it is responsible for managing and/or presenting.

The first mobile device 102 segments the media for presentation (block 308). That is, based on the attributes, the first mobile device 102 determines which coordinating devices will present what portions of the media. The attributes implicated in this decision may include, but are not limited to, processing speed, projector capabilities, audio capabilities, battery life, speaker quality, the presence or absence of a permanent power source (e.g., wall outlet), etc.

After the media has been segmented (block 308) the media is distributed to coordinating devices so that the coordinating devices have the media for which they are responsible for presenting (block 310).

Now turning to FIG. 4, an example method for media presentation is shown. Media is identified for presentation (block 402) by for example filenames or any other identifier. The media presentation is synchronized for presentation (block 404) using, for example, codes, timestamps or any other synchronization markers or tools, that can be used to establish the order in which information is to be placed for the presentation. The media may also be positionally synchronized through the use of visual indicators such as cross-hairs, or other graphics that may be embedded in the media or may be presented separate from the media that are monitored by the cameras of the mobile devices to allow for visual feedback regarding position. The media is then presented (block 406).

Further detail of certain aspects of the mobile devices 102, 104 of FIG. 1 are shown in FIG. 5 with respect to a mobile device 500. The mobile device 500 includes multiple components, such as a main processor 502 that controls the overall operation of the mobile device 500. Communication functions, including data and voice communications, are performed through a communication subsystem 504. Data received by the mobile device 500 is decompressed and decrypted by a decoder 506. The communication subsystem 504 receives messages from and sends messages to a wireless network 550. The wireless network 550 may be any type of wireless network, including, but not limited to, data wireless networks, voice wireless networks, and networks that support both voice and data communications. A power source 542, such as one or more rechargeable batteries or a port to an external power supply, powers the mobile device 500.

The processor 502 interacts with other components, such as Random Access Memory (RAM) 508, memory 510, a display 512 with a touch-sensitive overlay 514 operably coupled to an electronic controller 516 that together comprise a touch-sensitive display 518, one or more actuators 520, one or more force sensors 522, an auxiliary input/output (I/O) subsystem 524, a data port 526, a speaker 528, a microphone 530, short-range communications 532, and other device subsystems 534. (In other example embodiments, there is no touch-sensitive display and therefore touch-sensitive overlay 514, electronic controller 516, actuator(s) 520 and force sensor(s) 522 are not included in mobile device 500.) In one example, the processor 502 and the memory 510 may cooperate to implement the functionality described in conjunction with the controllers 124 and 134 of FIG. 1. For example, tangible and/or non-transitory, and/or machine readable instructions may be stored by the processor 502 and/or the memory 510 to implement the functionality shown in FIGS. 2-4.

Input via a graphical user interface is provided via the touch-sensitive overlay 514 (or in example embodiments in which there is no touch-sensitive display, input is provided via auxiliary input/output (I/O) subsystem 524). The processor 502 interacts with the touch-sensitive overlay 514 (or auxiliary input/output (I/O) subsystem 524) via the electronic controller 516. Information, such as text, characters, symbols, images, icons, and other items that may be displayed or rendered on a mobile device, is displayed on display 512 via the processor 502. The processor 502 may interact with an accelerometer 536 that may be utilized to detect direction of gravitational forces or gravity-induced reaction forces.

To identify a subscriber for network access, the mobile device 500 may utilize a Subscriber Identity Module or a Removable User Identity Module (SIM/RUIM) card 538 for communication with a network, such as the wireless network 550. Alternatively, user identification information may be programmed into memory 510.

The mobile device 500 includes an operating system 546 and software programs, applications, or components 548 that are executed by the processor 502 and are typically stored in a persistent, updatable store such as the memory 510. Additional applications or programs may be loaded onto the mobile device 500 through the wireless network 550, the auxiliary I/O subsystem 524, the data port 526, the short-range communications subsystem 532, or any other suitable subsystem 534.

The mobile device 500 also includes a camera 550 and a projector 552. As described above, the camera 550 and the projector 552 may interoperate to present information, wherein the presentation may be coordinated between several mobile devices.

A received signal such as a text message, an e-mail message, or web page download is processed by the communication subsystem 504 and input to the processor 502. The processor 502 processes the received signal for output to the display 512 and/or to the auxiliary 1/0 subsystem 524. A subscriber may generate data items, for example e-mail messages, which may be transmitted over the wireless network 550 through the communication subsystem 504. For voice communications, the overall operation of the mobile device 500 is similar. The speaker 528 outputs audible information converted from electrical signals, and the microphone 530 converts audible information into electrical signals for processing.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A mobile device comprising:
a projector to present images;
a communication subsystem to exchange information with at least one other mobile device;
a controller to control transmission of media, to the mobile device and the at least one other mobile device, based on attributes of the mobile device and the at least one other mobile device.

2. The mobile device of claim 1, wherein the communication subsystem receives attributes of the at least one other mobile device.

3. The mobile device of claim 2, wherein the attributes of the at least one other mobile device comprise data connectivity information.

4. The mobile device of claim 2, wherein data connectivity information comprises one or more of communication signal quality, data communication speed, or data network connectivity.

5. The mobile device of claim 2, wherein the attributes comprise one or more of remaining battery life or processing speed.

7. The mobile device of claim 1, wherein the communication subsystem exchanges information with the at least one other mobile.

8. The mobile device of claim 1, wherein the controller controls transmission of media to the mobile device and the at least one other mobile device.

9. The mobile device of claim 1, wherein the controller directs the transmission of media to the mobile device and the at least one other mobile device.

10. A mobile device comprising:
a projector to present images;
a communication subsystem to exchange information with at least one other mobile device;
a controller to control presentation of media based on attributes of the mobile device and attributes of the at least one other mobile device.

11. The mobile device of claim 10, wherein the communication subsystem receives attributes of the at least one other mobile device.

12. The mobile device of claim 11, wherein the attributes of the at least one other mobile device comprise data connectivity information.

13. The mobile device of claim 11, wherein the attributes comprise one or more of remaining battery life, processing speed, or projector capabilities.

14. The mobile device of claim 10, wherein the communication subsystem exchanges information directly with the at least one other mobile device.

15. The mobile device of claim 10, wherein the controller directs presentation of media by the mobile device and the at least one other mobile device.

16. The mobile device of claim 10, wherein the controller directs presentation of media by the mobile device and the at least one other mobile device.

17. A method for execution by a mobile device, the method comprising:
exchanging information with at least one other mobile device;
controlling transmission of media based on attributes of the mobile device and attributes of the at least one other mobile device; and
presenting the received media.

18. The method of claim 17, further comprising receiving attributes of the at least one other mobile device.

19. The method of claim 18, wherein the attributes of the at least one other mobile device comprise data connectivity information.

20. The method of claim 18, wherein data connectivity information comprises one or more of communication signal quality, data communication speed, or data network connectivity.

21. The method of claim 18, wherein the attributes comprise one or more of remaining battery life or processing speed.

22. The method of claim 17, further comprising controlling transmission of media to the mobile device and the at least one other mobile device.

23. The method of claim 17, further comprising directing the transmission of media to the mobile device and the at least one other mobile device.

24. A method for execution by a mobile device, the method comprising:
exchanging information with at least one other mobile device; and
controlling presentation of media based on attributes of the mobile device and attributes of the at least one other mobile device.

25. The method of claim 24, wherein further comprising receiving attributes of the at least one other mobile device.

26. The method of claim 25, wherein the attributes of the at least one other mobile device comprise data connectivity information.

27. The method of claim 25, wherein the attributes comprise one or more of remaining battery life, processing speed, or projector capabilities.

28. The method of claim 24, further comprising directing presentation of media by the mobile device and the at least one other mobile device.

29. The method of claim 24, further comprising directing presentation of media by the mobile device and the at least one other mobile device.
